(19) United States
(12) Patent Application Publication
(10) Pub. No.: US 2012/0269924 A1
(43) Pub. Date: Oct. 25, 2012

(54) CHEWING GUMS HAVING IMPROVED REMOVABILITY BASED ON LINEAR VISCOELASTIC SHEAR RHEOLOGY

(76) Inventors: David Phillips, Chicago, IL (US); Leslie D. Morgret, Evanston, IL (US); Xiaohu Xia, Evanston, IL (US); Chungsea Shen, Deerfield, IL (US)

(21) Appl. No.: 13/394,868

(22) PCT Filed: Sep. 10, 2010
(86) PCT No.: PCT/US10/48515

§ 371 Date: Jul. 10, 2012

Related U.S. Application Data
(60) Provisional application No. 61/241,080, filed on Sep. 10, 2009.
(60) Provisional application No. 61/325,529, filed on Apr. 19, 2010.
(60) Provisional application No. 61/325,542, filed on Apr. 19, 2010.

(51) Int. Cl. A23G 4/08

(52) U.S. Cl. 426/6; 426/3

(57) ABSTRACT

A chewing gum, when chewed, produces a cud having improved removability from environmental surfaces by virtue of its linear viscoelastic shear rheology. The cud has a specified temperature dependent storage modulus differential (Δ log G′/ΔT) at 25° C. and 60° C. Specifically, the cud has a temperature dependent storage modulus differential less than 0.050.

### CROSS-REFERENCE TO RELATED APPLICATIONS

This application claims benefit to U.S. Provisional Application No. 61/241,080 filed Sep. 10, 2009, U.S. Provisional Application No. 61/263,462 filed Nov. 23, 2009, U.S. Provisional Application No. 61/325,529 filed Apr. 19, 2010, U.S. Provisional Application No. 61/325,542 filed Apr. 19, 2010, all incorporated by reference herein.

### BACKGROUND OF THE INVENTION

The present invention relates to chewing gum and gum bases. More specifically, this invention relates to improved chewing gum and gum bases which form cuds having improved removability from environmental surfaces by virtue of their linear viscoelastic shear rheological response to temperature change.

The fundamental components of a chewing gum typically are a water-insoluble gum base portion and a generally water-soluble bulk portion. Typically, an elastomeric polymer provides the characteristic chewy texture of the product. The gum base will typically include other ingredients which modify the chewing properties or aid in processing the product. These include plasticizers, softeners, fillers, emulsifiers, plastic resins, as well as colorants and antioxidants. The generally water soluble portion of the chewing gum typically includes a bulking agent together with minor amounts of secondary components such as flavors, high-intensity sweeteners, colorants, water-soluble softeners, gum emulsifiers, acidulants and sensates. Typically, the water-soluble bulk portion, sensates, and flavors dissipate during chewing and the gum base is retained in the mouth throughout the chew. Even though they are often water insoluble, flavors and sensates are at least partially released with the water soluble bulking agent during chewing and are considered part of the water soluble portion.

One problem with traditional gum bases is the nuisance of gum litter when chewed gum cuds are improperly discarded. While consumers can easily dispose of chewed cuds in waste receptacles, some consumers intentionally or accidentally discard cuds onto sidewalks and other environmental surfaces. The nature of conventional gum bases can cause the improperly discarded cuds to adhere to the environmental surface and subsequently to be trampled by foot traffic into a flattened embedded mass which can be extremely difficult to remove.

This invention is directed to novel chewing gums and gum bases which, when chewed, produce cuds that, by virtue of their unique linear rheological properties, exhibit improved removability from environmental surfaces when compared to most commercially available chewing gums. Specifically, the present chewing gums produce cuds that exhibit improved removability due to their minimized differential of storage modulus (G′) at 25° C. and 60° C.

### SUMMARY OF THE INVENTION

A chewing gum is formulated to produce (after chewing) a cud with a temperature dependent storage modulus differential (Δ log G′/ΔT) less than 0.050. The chewing gum contains a water soluble portion and a water-insoluble gum base portion which is primarily responsible for affecting the cud's Δ log G′/ΔT.

### BRIEF DESCRIPTION OF THE DRAWINGS

FIG. 1 is a plot of Storage Modulus (G′) vs. Temperature for selected Examples.

FIG. 2 is a graph of removal residue vs. temperature dependent storage modulus differential (Δ log G′/ΔT) for cuds formed from various inventive and comparative chewing gum formulations.

### DESCRIPTION OF THE INVENTION

The present invention provides improved chewing gums and chewing gum bases, as well as methods of producing chewing gum and chewing gum bases. In accordance with the present invention, novel chewing gum bases and chewing gums are provided that cause the cud to exhibit a temperature dependent storage modulus differential (Δ log G′/ΔT) less than 0.050 as measured using a rotational rheometer and calculated from the equation: abs[ log G′_{60° C.}−log G′_{25° C.}]/(60° C.−25° C.). (The detailed method is described below.)

A variety of gum base and chewing gums that satisfy the requirements of the claimed invention can be created using gum base systems described below. In some embodiments, the present invention provides for chewing gums containing gum bases which are conventional gum bases that include wax or are wax-free. In some embodiments, the present invention provides for chewing gums that can be low or high moisture containing low or high amounts of moisture-containing syrup. Low moisture chewing gums are those which contain less than 1.5% or less than 1% or even less than 0.5% water. Conversely, high moisture chewing gums are those which contain more than 1.5% or more than 2% or even more than 2.5% water. The chewing gums can be used sugar-containing chewing gums or may be low sugar or non-sugar containing gum formulations made with sorbitol, mannitol, other polyols, and non-sugar carbohydrates.

While Δ log G′/ΔT is primarily determined by the water insoluble gum base composition, components in the generally water soluble bulk portion may exert at least a minor influence on the cud rheology as well. Flavors and sensates (and other water insoluble components which constitute a minor percentage of the generally water soluble bulk portion) are particularly likely to affect the (Δ log G′/ΔT).

Previously known chewing gums, upon chewing, typically produce a cud having a storage modulus of about 10⁵ to about 10⁷ Pa at 37° C. (when measured as described in the Rheological Testing method provided herein) to provide satisfactory chewing properties at room and mouth temperatures. However, at higher temperatures, G′ drops off rapidly, typically to less than 10⁵ Pa at 60° C. Without wishing to be bound by theory, it is believed that the gum cuds produced from such products are relatively firm and non-flowing at mouth or room temperature but may flow into pores and crevices in rough environmental surfaces such as concrete heated by the summer sun. When the concrete later cools, the cud returns to its firmer texture and may mechanically “lock” into the rough concrete surface. After a number of such heat/cool cycles, the gum cud becomes almost impossible to remove from the concrete to which it has become adhered. By contrast, gum cuds of the present invention may have a similar G′ at room and mouth temperatures, but a higher G′ at 60° C. compared to prior art gums. As a result, the cud's viscoelastic properties do not shift radically over the temperature range to which outdoor concrete is subjected and the cuds do not exhibit the flow and lock cycles, at least not to the same degree as prior art gum cuds.

Typically, gum bases usable in the present invention have sufficient chewing cohesion such that a chewing gum composition containing such material forms a discrete gum cud with consumer acceptable chewing characteristics.

In order to maintain acceptable chewing properties, in some embodiments of the present invention, the chewing gum will produce a cud having storage modulus (G′) of from 10⁵ Pa to 10⁷ Pa at 37° C. when measured as described herein.

In some embodiments, the chewing gum will incorporate a gum base containing a food grade tri-block copolymer in the form A-B-A or A-B-C having a soft mid-block and hard end-blocks wherein the soft mid-block comprises at least 30 wt. % of the tri-block copolymer and wherein the hard end-blocks each have a T_{g} below 70° C. as disclosed in copending application U.S. 61/241,080.

In embodiments of the present invention which employ tri-block copolymers, the triblock copolymers will have a soft mid-block polymer covalently bonded to two hard end-block polymers in an A-B-A or A-B-C configuration. By a soft mid-block it is meant that the middle or “B” block is composed of a polymer having a glass transition temperature substantially below mouth temperature. Specifically, the polymer comprising the soft block will have a T_{g} below 20° C. Preferably, the polymer comprising the soft block will have a T_{g} below 10° C. Even more preferably, the polymer comprising the soft block will have a T_{g} below 0° C. Soft polymers will also have a complex shear modulus between 10³ and 10⁸ Pascals at 37° C. and 1 rad/sec. Preferably, the shear storage modulus will be between 10⁴ and 10⁷ more preferably between 5×10⁵ and 5×10⁶ at 37° C. and 1 rad/sec. In an embodiment, the soft mid-block comprises polyisoprene. In an embodiment, the soft mid-block comprises poly(6-methylcaprolactone). In an embodiment, the soft mid-block comprises poly(6-butyl-ε-caprolactone. In an embodiment, the soft mid-block comprises other polymers of alkyl or aryl substituted ε-caprolactones. In an embodiment, the soft mid-block comprises polydimethylsiloxane. In an embodiment, the soft mid-block comprises polybutadiene. In an embodiment, the soft mid-block comprises polycyclooctene. In an embodiment, the soft mid-block comprises polyvinyllaurate. In an embodiment, the soft mid-block comprises polyethylene oxide. In an embodiment, the soft mid-block comprises polyoxymethylene. In an embodiment, the soft mid-block comprises polymenthide. In an embodiment, the soft mid-block comprises polyfarnesene. In an embodiment, the soft mid-block comprises polymyrcene. In some embodiments, the soft mid-block may be a random or alternating copolymer. Generally, the soft mid-block will be non-crystalline at typical storage and mouth temperatures. However, it may be acceptable for the soft mid-block to have some semi-crystalline domains.

By hard end-blocks, it is meant that the end or “A” and/or C block(s) comprise essentially identical polymers (in the case of the A-B-A form) or compatible or incompatable polymers (in the case of the A-B-C form) having a T_{g}. above about 20° C. Preferably, the polymer(s) comprising the hard end-blocks will have a T_{g} above 30° C. or even above 40° C. It is also important that the hard polymer(s) have a T_{g} sufficiently low as to allow convenient and efficient processing, especially when the tri-block copolymer or tri-block elastomer system is to be used as the sole component in a gum base. Thus the hard polymer(s) should have a T_{g} below 70° C. and preferably below 60° C. In an embodiment, the hard polymer(s) will have a T_{g} between 20° C. and 70° C. In an embodiment, the hard polymer(s) will have a T_{g} between 20° C. and 60° C. In an embodiment, the hard polymer(s) will have a T_{g} between 30° C. and 70° C. In an embodiment, the hard polymer(s) will have a T_{g} between 30° C. and 60° C. In an embodiment, the hard polymer(s) will have a T_{g} between 40° C. and 70° C. In an embodiment, the hard polymer(s) will have a T_{g} between 40° C. and 60° C. Use of hard polymers having this T_{g} range allows lower processing temperatures, reduced mixing torque and shorter mixing times. This results in energy savings and effectively increased mixing capacity. In continuous mixing extruders the problem of excess heat buildup is reduced. In an embodiment, the hard end-block comprises polylactide (PLA). In an embodiment, the hard end-block comprises polyvinylacetate. In an embodiment, the hard end-block comprises polyethylene terephthalate. In an embodiment, the hard end-block comprises polyglycolic acid. In an embodiment, the hard end-block comprises poly(propyl methacrylate). In some embodiments, the hard end-blocks may be random or alternating copolymers. Typically, the hard end-blocks will be amorphous or semi-crystalline at storage and chewing temperatures.

It is preferred that the soft mid-block and hard end-blocks be incompatible with each other to maximize the formation of internal microdomains as described below. Methods of testing for compatibility are also described below.

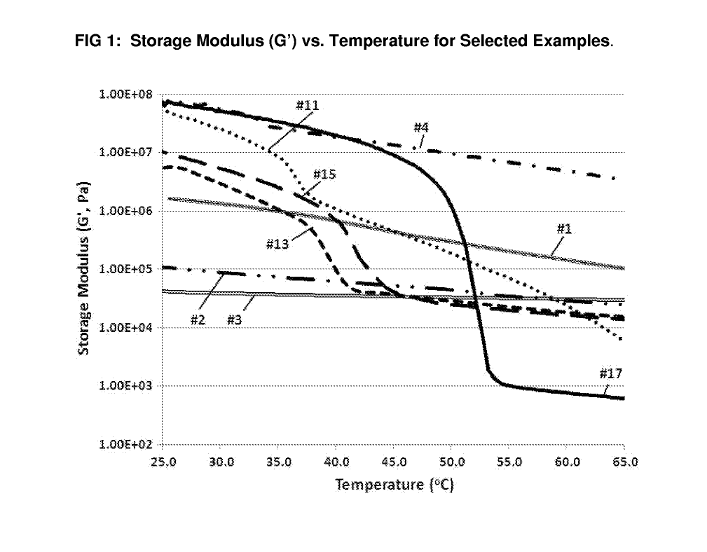

Glass transition temperatures of the hard and soft blocks can be conventionally measured using Differential Scanning Calorimetry (DSC) as is well known in the art. Triblock copolymers of the present invention will have DSC thermograms which display two (or possibly three in the case of A-B-C triblock copolymers) glass transitions; a low temperature transition corresponding to the T_{g} of the soft block and one or two high temperature transitions corresponding to the T_{g} of the hard blocks. (See FIG. 1.) In some cases it may be difficult to detect the hard-block transition(s), particularly when the soft block greatly exceeds 50% of the total mass of the polymer. In such cases, a homopolymer of one or both blocks may be synthesized to a similar molecular weight and tested by DSC to determine the T_{g}.

In the tri-block copolymers usable in the present invention, the soft mid-block will constitute at least 40%, preferably at least 50% or at least 60% by weight of the total polymer. This insures that the polymer will provide the elasticity necessary to function as an elastomer in the gum base. The remainder of the tri-block copolymer will comprise the hard end-blocks. Thus, the combined weight of the two end-blocks will be less than 60% and preferably less than 50% or 40% by weight of the total polymer.

In most cases, particularly when the tri-block copolymer has an A-B-A configuration, the two hard end-blocks will be of approximately equal molecular weight. That is, the ratio of their molecular weights will be between 0.8:1 and 1:1. However, it is also contemplated that they may be of substantially unequal lengths such as 0.75:1 or 0.70:1 or 0.60:1 or even 0.50:1 or 0.30:1, particularly when the triblock copolymer has an A-B-C configuration.

The molecular weight of the tri-block copolymer will be selected to provide the desired textural properties when incorporated into a chewing gum base or chewing gum. The optimal molecular weight for this purpose will vary depending upon the specific polymeric blocks chosen and the composition of the gum base or gum product, but generally it will fall into the range of 6,000 to 400,000 daltons. More typically, it will fall into the range of 20,000 to 150,000 daltons. Tri-block copolymers with excessive molecular weight will be too firm to chew when incorporated into gum base and chewing gum compositions. In addition, they may be difficult to process. Tri-block copolymers with insufficient weight may lack proper chewing cohesion, firmness and elasticity for chewing and may additionally pose regulatory and food safety concerns.

Such tri-block copolymers, when incorporated into gum bases and chewing gums and chewed, can produce cuds which have the claimed temperature dependent storage modulus differential and which are more easily removed from environmental surfaces if improperly discarded. It is believed that this is due to the formation of internal structures which optimize the cohesivity of the cud and minimize temperature-related changes in their viscoelastic properties which cause the flow and lock cycles which result in severe adhesion of cuds to rough surfaces. These internal structures are caused by microphase domain separation and subsequent ordering of the hard and soft domains of the polymer molecules.

In some embodiments of this invention, the gum base will contain a tri-block copolymer as described above combined with a di-block copolymer comprising a soft block and a hard block which are compatible with the soft and at least one of hard blocks respectively in the tri-block copolymer. In these embodiments, the di-block copolymer plasticizes the tri-block copolymer to provide a plasticized elastomer material which is consistent with the chew properties of conventional elastomer/plasticizer systems. The di-block plasticizer may also provide additional benefits such as controlling release of flavors, sweeteners and other active ingredients, and reducing surface interactions of discarded cuds for improved removability from environmental surfaces.

In other embodiments, the chewing gum will incorporate crosslinked polymeric microparticles as disclosed in copending application U.S. 61/263,462. The crosslinked polymer may have a glass transition temperature of less than about 30° C., or less than about 10° C. or even less than about 0° C. In some embodiments, the crosslinked polymer may have a complex modulus (G*) at 25° C. of less than about 10⁹ dyne/cm², or less than about 10⁷ dyne/cm². In yet other embodiments, the crosslinked polymer may desirably have a complex modulus (G*) of greater than about 10⁴ dyne/cm², or greater than about 10⁵ dyne/cm².

The microparticles may have a largest dimension of at least about 0.1 microns or at least about 0.5 microns or at least about 10 microns. The microparticles may have a largest dimension of less than about 1000 microns, or less than about 500 microns or less than about 100 microns.

In some embodiments, the microparticles may comprise a food grade polymer and may or may not be plasticized. In these, and other, embodiments, the polymer may comprise a polyacrylate, a polyurethane, or copolymers of these. If a polyacrylate is desired, the polyacrylate may be prepared from at least one acrylate monomer comprising isooctyl acrylate, 4-methyl-2-pentyl-acrylate, 2-methylbutyl acrylate, isoamyl acrylate, sec-butyl acrylate, n-butyl acrylate, 2-ethylhexyl acrylate, isodecyl methacrylate, isononyl acrylate, isodecyl acrylate or combinations of these. In certain embodiments, when a polyacrylate is desirably used, it may be prepared from isoctyl acrylate, 2-ethylhexyl acrylate, n-butyl acrylate, or combinations of these.

In yet other embodiments, the chewing gum will incorporate a gum base containing from 45 to 95% by weight of low molecular weight polyethylene having a weight average molecular weight between 2000 and 23000 daltons as disclosed in copending application U.S. 61/325,542. In some embodiment, the gum base will comprise 50 to 75 wt. % or 55 to 70 wt. % polyethylene. In some embodiments, the gum base contains 3 to 30 wt. % of at least one elastomer. In some embodiments, the gum base will comprise 5 to 28 wt. % of at least one elastomer or even at 8 to 25 wt. % of at least one elastomer. In some embodiments, the gum base will comprise 0 to 30 wt. % or 0 to 20 wt. % or 0 to 10 wt. % of a plastic resin such as polyvinyl acetate.

The above identified polymers suitable for inclusion in a gum base are examples of what may be referred to as “controlled flow polymers” due to their relative resistance to flow at higher temperatures. Such polymers are useful in the present invention due to their low temperature dependent storage modulus differential. However, the present invention is not limited to these specific polymers. In fact, it is specifically contemplated that other controlled flow polymers are useful in the present invention. Additionally, chewing gums of the present invention using only conventional polymers may be formulated to produce cuds having the claimed temperature dependent storage modulus differential. Conversely, cuds from some chewing gums which incorporate controlled flow polymers may not exhibit the claimed temperature dependent storage modulus differential due to added plasticizers or other aspects of the formula and/or processing. It is this temperature dependent storage modulus differential of the cud which defines the invention rather than any particular ingredient, formula or process.

In some embodiments, the chewing gums of the present invention will contain food grade gum bases. As used herein, the term ‘food grade’ is meant to indicate that the material meets all legal requirements for use in a food product in the intended market and/or manufacturing location. While requirements for being food grade vary from country to country, food grade polymers intended for use as masticatory substances (i.e. gum base) may typically have to: i) be approved by the appropriate local food regulatory agency for this purpose; ii) be manufactured under “Good Manufacturing Practices” (GMPs) which may be defined by local regulatory agencies, such practices ensuring adequate levels of cleanliness and safety for the manufacturing of food materials; iii) be manufactured with food grade materials (including reagents, catalysts, solvents and antioxidants) or materials that at least meet standards for quality and purity; iv) meet minimum standards for quality and the level and nature of any impurities present; v) be provided with an adequately documented manufacturing history to ensure compliance with the appropriate standards; and/or vi) be manufactured in a facility that itself is subject to inspection by governmental regulatory agencies. All of these standards may not apply in all jurisdictions, and all that is required in those embodiments wherein the gum base is desirably food grade is that the polymer meets the standards required by the particular jurisdiction.

For example, in the United States, ingredients are approved for use in food products by the Food and Drug Administration. In order to gain approval for a new food or color additive, a manufacturer or other sponsor must petition the FDA for its approval. Petition is not necessary for prior-sanctioned substances or ingredients generally recognized as safe (GRAS ingredients) and these are specifically included within the meaning of the term “food grade” as used herein. Information on the regulatory process for food additives and colorants in the U.S. can be found at http://www.fda.gov/Food/FoodIngredientsPackaging/ucm094211.htm, the entire contents of which are incorporated by reference herein for any and all purposes

In Europe, one example of a governing agency is the European Commission, Enterprise and Industry. Information of the European Commission's regulation of the food industry in Europe can be found at http://ec.europa.eu/enterprise/sectors/food/index_en.htm, the entire contents of which are incorporated by reference herein for any and all purposes.

Gum bases typically contain one or more polymeric elastomers and the entire gum base composition (and cuds formed by chewing it) is itself a weak elastomer. An elastomer is a material which is capable of being deformed by physical application of stress (for example compression or stretching) and then returning to its approximate original size and shape when the stress is released. During the time the material is deformed, it stores the energy which will return the material to its original size and shape when the stress is released. That stored energy is called “Storage Modulus” and is designated as G′. Materials with a high G′ tend to be harder and rubbery while those with a low G′ tend to be soft and malleable. The storage modulus for a given material may vary significantly with the temperature of the material.

While there can be many variations in how the storage modulus of a gum cud might be measured, the values presented here (and upon which the claims are based) are measured are based on a specific testing methodology. For purposes of the present invention, the temperature dependent storage modulus differential (Δ log G′/ΔT) is defined as the value derived from this disclosed testing methodology and the accompanying equation.

Cud Preparation: Approximately two to eight grams of chewing gum are chewed for at least 20 minutes. Alternatively, water soluble components may be extracted by placing a thin strip of chewing gum under running water overnight followed by kneading the gum by hand under running water for an additional two minutes. Yet another method is to knead the gum under running water for at least 20 minutes. Any of these methods should be sufficient to remove essentially all of the water soluble components from the cud. The cud is then aged by placing it on a silicone baking pad. A second silicon pad is placed on top of the cud and a 150 to 200 pound person wearing flat soled shoes steps on the cud, applying their full weight for approximately two seconds. The upper pad is then removed and the lower pad with cud attached is placed in a 50° C./10% RH oven for five days to simulate two weeks of aging in hot, dry conditions which are known to produce severe adhesion of conventional gum cuds to sidewalks.

Rheology Testing: A rotational rheometer (such as an ARES, AR, Kinexus or Physica MCR model) is used to measure the small angle oscillatory shear rheology of the cud in a temperature sweep mode. The gum cud is removed from the aging oven and allowed to equilibrate to room conditions overnight before testing. A quantity of the aged cud sufficient to completely fill the gap is placed on a 25 mm parallel plate fixture and the gap is initially closed until material extends beyond the periphery of the fixture. Excess cud material is trimmed from the plate edges. The gap is then typically closed slightly to ensure that the cud material completely fills the gap. 1.0 to 2.0 mm and any excess material is again removed before testing. In instances where a cud mass is insufficient to fill the above configured plate fixture, or where the cud is too hard at room temperature causing transducer compliance problems, an 8 mm plate may be substituted. The instrument is set as follows:
Strain: 0.1% (or less if a strain sweep at 20° C. indicates that 0.1% is outside the linear viscoelastic region)
Oscillation: 10 radians/second
Normal force: 0 to 0.1 Newtons
Temperature sweep: Sweep 20° C. to 80° C. at 3°/min
   Hold 5 Minutes
   Sweep 80° C. to 20° C. at 3°/min
   (A chiller may be required)
Auto strain adjustment On
   Adjustment: 20%
   Minimum strain 0.01%
   Maximum strain 1.0%
   Minimum torque 10 micronewton*m
   Maximum torque 1000 micronewton*m)
Axial force adjustment On
   Force 0.0N
   Sensitivity 0.1 N)

Using the cooling temperature sweep, a plot of G′ versus Temperature is generated from which values for G′ at 25° C. and 60° C. may be read. By inserting these values into the equation below, the temperature dependent storage modulus differential may be calculated.

$$Δ log {G}^{′} / Δ T = \frac{abs [ log {G}_{60 \underline{°} C .}^{′} - log {G}_{25 \underline{°} C .}^{′} ]}{( 60 \underline{°} C . - 25 \underline{°} C . )} = \frac{abs [ log {G}_{60 \underline{°} C .}^{′} - log {G}_{25 \underline{°} C .}^{′} ]}{35 ° C .}$$

Removability Testing: Two grams of gum is chewed or extracted under water as above. The cud is then immediately placed on the bottom (untapered) side of a 5.5×5.5×2.38 inch concrete paver stone (Canterbury model produced by Unilock Company of Toronto, ON, Canada) and covered with silicone coated paper. Approximately 200 pounds of pressure is applied to the cud (for example by stepping on it with a flat soled shoe) for approximately two seconds. The silicone-coated paper is then removed and the adhered cud and paver stone are conditioned at 50° C./10% RH for 24 hours. In some cases, it may be possible to completely remove the cud by grasping a portion and carefully peeling it from the paver leaving no visible residue. Where this is not possible, a flat-edged metal scraper held at a 15° angle is used to make a single pass over the cud over one to five seconds, depending on resistance. The results are then evaluated using image analysis software, such as ImageJ 1.41o from the National Institutes of Health, to measure the portion of the cud remaining. Easily removed cuds will leave no more than 20% of the original gum cud surface area as residue and require no more than approximately 50 N of force. Of course, it is desirable that the cud leaves even less residue and require less force to remove with minimized residue being the more important of the two criteria. Preferably, no more than 10% or 5% residue (by area) will remain after the single pass with the scraper.

In some embodiments of the present invention, the chewing gum will produce a cud which leaves less than 10% of the original gum cud surface area as residue after a single pass with a metal scraper as measured by the above procedure.

Removability testing has determined that gum cuds having Δ log G′/ΔT less than 0.050 as measured in the above manner tend to have improved removability from concrete surfaces. In some embodiments of the present invention, a chewing gum, when chewed, will produce a gum cud having a Δ log G′/ΔT less than 0.050. In other embodiments, chewing gums of the present invention will have a Δ log G′/ΔT less than 0.045. In other embodiments, chewing gums of the present invention will have a Δ log G′/ΔT less than 0.040. In still other embodiments, chewing gums of the present invention will have a Δ log G′/ΔT less than 0.035. In yet other embodiments, chewing gums of the present invention will have a Δ log G′/ΔT less than 0.030.

The chewing gums of the present invention typically produce cuds that are pleasant and enjoyable to chew. Typically, cuds have acceptable chewing properties when their G′ is in the range of 10⁵ to 10⁷ Pa at 37° C. Desirably, they are weakly elastomeric at mouth temperature in the sense of having an ability to be stretched to 150 to 200% of an original length and to recover, to a length at least slightly less than the stretched length.

In preferred embodiments of the present invention, cuds formed from chewing gums of the present invention are readily removable from concrete if they should become adhered to such a surface. For example, such cuds may be removable by use of typical high power washing apparatuses in no more than 20 seconds. Alternatively, the mass may be easily removable by use of a metal scraper with one or two scrapings or even by peeling it off with fingers. By ‘readily removable from concrete’, it is meant that the cuds which are experimentally adhered to concrete according to the removability testing method previously described can be removed by a single pass with a metal scraper, or by power washing for up to 60 seconds or finger peeling leaving less than 20% or less than 10% or less than 5% of the initial cud mass after a removal attempt using the best of the above methods. Note that the best removal method may differ depending on the nature of the cud and/or the concrete surface. It will often be necessary to determine the best method on a case-by-case basis.

In some embodiments, the chewing gums of the present invention may contain an elastomer or elastomer/plasticizer combinations such as a tri-block copolymer or tri-block/di-block copolymer blend (as previously described.) as the sole component of the insoluble gum base. In other embodiments, the gum base elastomers and plasticizers will be combined with softeners, fillers, colors, antioxidants and other conventional, non-elastomeric gum base components. In addition to the gum base, chewing gums of the present invention will typically contain water-soluble bulking agents, flavors, high-intensity sweeteners, colors, pharmaceutical or nutraceutical agents and other optional ingredients. These chewing gums may be formed into sticks, tabs, tapes, coated or uncoated pellets or balls or any other desired form. By formulating the chewing gum to produce a cud having a Δ log G′/ΔT less than about 0.050, consumer-acceptable chewing gum products can be manufactured which exhibit improved removability from environmental surfaces, especially concrete.

In order to further enhance the removability of cuds formed from gums of the present inventions, it may be desirable to incorporate other known removability-enhancing features into the chewing gum or gum base. For example, certain additives such as emulsifiers and amphiphilic polymers may be added. Another additive which may prove useful is a polymer having a straight or branched chain carbon-carbon polymer backbone and a multiplicity of side chains attached to the backbone as disclosed in WO 06-016179. Still another additive which may enhance removability is a polymer comprising hydrolyzable units or an ester and/or ether of such a polymer. One such polymer comprising hydrolyzable units is a copolymer sold under the Trade name Gantrez®. Addition of such polymers at levels of 1 to 20% by weight of the gum base may reduce adhesion of discarded gum cuds. These polymers may also be added to the gum mixer at a level of 1 to 7% by weight of the chewing gum composition.

Another approach to enhancing removability of the present invention involves formulating gum bases to contain less than 5% (i.e. 0 to 5%) of a calcium carbonate and/or talc filler and/or 5 to 40% amorphous silica filler. Formulating gum bases to contain 5 to 15% of high molecular weight polyisobutylene (for example, polyisobutylene having a weight average or number average molecular weight of at least 200,000 Daltons) is also effective in enhancing removability. High levels of emulsifiers such as powdered lecithin may be incorporated into the chewing gum at levels of 3 to 7% by weight of the chewing gum composition. It may be advantageous to spray dry or otherwise encapsulate the emulsifier to delay its release. Any combination of the above approaches may be employed simultaneously to achieve improved removability. Specifically, removability can be enhanced by combining a controlled flow polymer with 0 to 5% of a calcium carbonate or talc filler, 5 to 40% amorphous silica filler, 5 to 15% high molecular weight polyisobutylene, 1 to 20% of a polymer having a straight or branched chain carbon-carbon polymer backbone and a multiplicity of side chains attached to the backbone and further incorporating this gum base into a chewing gum comprising 3 to 7% of an emulsifier, such as lecithin, which is preferably encapsulated such as by spray drying. Many variations on this multi-component solution to the cud adhesion problem can be employed. For example, the polymer having a straight or branched chain carbon-carbon polymer backbone or the ester and/or ether of a polymer comprising hydrolyzable units may be added to the gum mixer instead of incorporating it into the gum base, in which case it may be employed at a level of 1 to 7% of the chewing gum composition. Also, in some cases it may be desirable to omit one or more of the above components for various reasons.

Any of the above removability enhancing formulation approaches may be employed so long as the linear viscoelastic properties (specifically Δ log G′/ΔT) of the resulting cud are maintained in the claimed range.

Chewing gums of the present invention afford the chewing gum consumer acceptable texture, shelf life and flavor quality. Because cuds having the described properties have chewing properties similar to other cuds in most respects, gum bases containing them create a resultant chewing gum product that has a high consumer-acceptability.

The water-insoluble gum base used in chewing gums of the present invention may optionally contain conventional petroleum-based elastomers and elastomer plasticizers such as styrene-butadiene rubber, butyl rubber, polyisobutylene, terpene resins and estergums. Where used, these conventional elastomers may be combined in any compatible ratio with the specific, unconventional elastomers described above or in other suitable elastomer systems. In a preferred embodiment, significant amounts (more than 1 wt. %) of these conventional elastomers and elastomer plasticizers are not incorporated into a gum base of the present invention. In other preferred embodiments, less than 15 wt. % and preferably less than 10 wt. % and more preferably less than 5 wt. % of petroleum-based elastomers and elastomer plasticizers are contained in the gum base of the present invention. Other ingredients which may optionally be employed include inorganic fillers such as calcium carbonate and talc, emulsifiers such as lecithin and mono- and di-glycerides, plastic resins such as polyvinyl acetate, polyvinyl laurate, and vinylacetate/vinyl laurate copolymers, colors and antioxidants.

The water-insoluble gum base used in present invention may constitute from about 5 to about 95% by weight of the chewing gum. More typically it may constitute from about 10 to about 50% by weight of the chewing gum and, in various preferred embodiments, may constitute from about 20 to about 35% by weight of the chewing gum.

An example of a gum base useful in this invention may include about 5 to 100 wt. % of one or more plasticized or unplasticized controlled flow polymers, 0 to 20 wt. % synthetic elastomer, 0 to 20 wt. % natural elastomer, about 0 to about 40% by weight elastomer plasticizer, about 0 to about 35 wt. % filler, about 0 to about 35 wt. % softener, and optional minor amounts (e.g., about 1 wt. % or less) of miscellaneous ingredients such as colorants, antioxidants, and the like.

Further, a typical gum base includes at least 5 wt. % and more typically at least 10 wt. % softener and includes up to 35 wt. % and more typically up to 30 wt. % softener. Still further, a typical gum base includes 5 to 40 wt. % and more typically 15 to 30 wt. % hydrophilic modifier such as polyvinylacetate. Minor amounts (e.g., up to about 1 wt. %) of miscellaneous ingredients such as colorants, antioxidants, and the like also may be included into such a gum base.

In an embodiment, a chewing gum base of the present invention contains about 4 to about 35 weight percent filler, about 5 to about 35 weight percent softener, about 5 to about 40% hydrophilic modifier and optional minor amounts (about one percent or less) of miscellaneous ingredients such as colorants, antioxidants, and the like.

Additional elastomers may include, but are not limited to, polyisobutylene having a viscosity average molecular weight of about 100,000 to about 800,000, isobutylene-isoprene copolymer (butyl elastomer), polyolefin thermoplastic elastomers such as ethylene-propylene copolymer and ethylene-octene copolymer, styrene-butadiene copolymers having styrene-butadiene ratios of about 1:3 to about 3:1 and/or polyisoprene, and combinations thereof. Natural gums which may be similarly incorporated into the gum bases of the present inventions include jelutong, lechi caspi, perillo, sorva, massaranduba balata, massaranduba chocolate, nispero, rosindinha, chicle, gutta hang kang, and combinations thereof.

The elastomer component of gum bases used in this invention may contain up to 100 wt. % of one or more controlled flow polymers. In some embodiments, the controlled flow polymer(s) may be combined with compatible plasticizers and the plasticized copolymer system may be used as the sole components of a gum base. Alternatively, mixtures of plasticized or unplasticized controlled flow polymers with other elastomers also may be used. In such embodiments, mixtures with conventional elastomeric components of gum bases may comprise least 10 wt. % plasticized or unplasticized controlled flow polymer(s), typically at least 30 wt. % and preferably at least 50 wt. % of the combined elastomer system. In order to provide for improved removability of discarded gum cuds form environmental surfaces, gum bases usable in the present invention may contain an elastomeric component which comprises at least 10%, preferably at least 30%, more preferably at least 50% and up to 100 wt. % plasticized or unplasticized controlled flow polymer(s) in addition to other non-elastomeric components which may be present in the gum base. Due to cost limitations, processing requirements, sensory properties and other considerations, it may be desirable to limit the elastomeric component of the gum base to no more than 90%, or 75% or 50% by weight or even less.

A typical gum base usable in the present invention may have a complex shear modulus (the measure of the resistance to the deformation) of 1 kPa to 10,000 kPa at 40° C. (measured on a Rheometric Dynamic Analyzer with dynamic temperature steps, 0-100° C. at 3° C./min; parallel plate; 0.5% strain; 10 rad/sec). Preferably, the complex shear modulus will be between 10 kPa and 1000 kPa at the above conditions. Gum bases having shear modulus in these ranges have been found to have acceptable chewing properties.

A controlled flow polymer used in this invention typically should be free of strong, undesirable off-tastes (i.e. objectionable flavors which cannot be masked) and have an ability to incorporate flavor materials which provide a consumer-acceptable flavor sensation. Suitable controlled flow polymers should also be safe and food acceptable, i.e. capable of being food approved by government regulatory agencies for use as a masticatory substance, i.e. chewing gum base. Furthermore, it is preferable that the polymers be prepared using only food safe catalysts, reagents and solvents.

It is known to use proteins such as zein and gluten as elastomers or even entire gum bases. Although it may be possible to formulate chewing gums of the present invention using such proteins, there have been no known attempts to do so. Furthermore, previous testing of these materials has found them generally unsuitable for use as chewing gum elastomers due to off flavors, poor chewing texture, shelf life concerns and high cost in some cases. Therefore, it is strongly preferred that chewing gums of the present invention be essentially free of protein gum base components. By ‘essentially free’ it is meant that the gum base should contain less than 5% protein and preferably it should contain none.

Elastomer plasticizers commonly used for petroleum-based elastomers may be optionally used in this invention including, but not limited to, natural rosin esters, often called estergums, such as glycerol esters of partially hydrogenated rosin, glycerol esters of polymerized rosin, glycerol esters of partially or fully dimerized rosin, glycerol esters of rosin, pentaerythritol esters of partially hydrogenated rosin, methyl and partially hydrogenated methyl esters of rosin, pentaerythritol esters of rosin, glycerol esters of wood rosin, glycerol esters of gum rosin; synthetics such as terpene resins derived from alpha-pinene, beta-pinene, and/or d-limonene; and any suitable combinations of the foregoing. The preferred elastomer plasticizers also will vary depending on the specific application, and on the type of elastomer which is used.

In addition to natural rosin esters, also called resins, elastomer solvents may include other types of plastic resins. These include polyvinyl acetate having a GPC weight average molecular weight of about 2,000 to about 90,000, polyethylene, vinyl acetate-vinyl laurate copolymer having vinyl laurate content of about 5 to about 50 percent by weight of the copolymer, and combinations thereof. Preferred weight average molecular weights (by GPC) for polyisoprene are 50,000 to 80,000 and for polyvinyl acetate are 10,000 to 65,000 (with higher molecular weight polyvinyl acetates typically used in bubble gum base). Because polyvinyl acetate undergoes a glass transition in the range of 25° to 60° C., its use may tend to raise the Δ log G′/ΔT of the gum cud. For this reason it is preferred to limit the polyvinyl acetate content to no more than 10% of the chewing gums of the present invention.

Additionally, a gum base may include fillers/texturizers and softeners/emulsifiers. Softeners (including emulsifiers) are added to chewing gum in order to optimize the chewability and mouth feel of the gum.

Softeners/emulsifiers that typically are used include triglyceride mixtures such as tallow, hydrogenated tallow, hydrogenated and partially hydrogenated vegetable oils and cocoa butter. Also useful are mono- and di-glycerides such as glycerol monostearate, glycerol triacetate, lecithin, paraffin wax, microcrystalline wax, natural waxes and combinations thereof. Lecithin and mono- and di-glycerides also function as emulsifiers to improve compatibility of the various gum base components. Because hydrogenated and partially hydrogenated vegetable oils, as well as animal fats, often exhibit a phase change in the range of 25° to 60° C., excessive levels can raise Δ log G′/ΔT of the resulting gum cud. In some embodiments of the present invention the chewing gum contains less than 10% of triglycerides.

Fillers/texturizers typically are inorganic, water-insoluble powders such as magnesium and calcium carbonate, ground limestone, silicate types such as magnesium and aluminum silicate, clay, alumina, talc, titanium oxide, mono-, di- and tri-calcium phosphate and calcium sulfate. Insoluble organic fillers including cellulose polymers such as wood as well as combinations of any of these also may be used.

Colorants and whiteners may include FD&C-type dyes and lakes, fruit and vegetable extracts, titanium dioxide, and combinations thereof.

Antioxidants such as BHA, BHT, tocopherols, propyl gallate and other food acceptable antioxidants may be employed to prevent oxidation of fats, oils and elastomers in the gum base.

As noted, the base may include wax or be wax-free. An example of a wax-free gum base is disclosed in U.S. Pat. No. 5,286,500, the disclosure of which is incorporated herein by reference.

A water-insoluble gum base typically constitutes approximately 5 to about 95 percent, by weight, of a chewing gum of this invention; more commonly, the gum base comprises 10 to about 50 percent of a chewing gum of this invention; and in some preferred embodiments, 20 to about 35 percent, by weight, of such a chewing gum.

In addition to the water-insoluble gum base portion, a typical chewing gum composition includes a water-soluble bulk portion (or bulking agent) and one or more flavoring agents. The water-soluble portion can include high intensity sweeteners, binders, flavoring agents (which may be water insoluble), water-soluble softeners, gum emulsifiers, colorants, acidulants, fillers, antioxidants, and other components that provide desired attributes.

Water-soluble softeners, which may also known as water-soluble plasticizers and plasticizing agents, generally constitute between approximately 0.5 to about 15% by weight of the chewing gum. Water-soluble softeners may include glycerin, triacetin, and combinations thereof. Aqueous sweetener solutions such as those containing sorbitol, maltitol, mannitol, hydrogenated starch hydrolysates (HSH), corn syrup and combinations thereof, may also be used as softeners and binding agents (binders) in chewing gum.

Preferably, a bulking agent or bulk sweetener will be useful in chewing gums of this invention to provide sweetness, bulk and texture to the product. Typical bulking agents include sugars, sugar alcohols, and combinations thereof. Bulking agents typically constitute from about 5 to about 95% by weight of the chewing gum, more typically from about 20 to about 80% by weight and, still more typically, from about 30 to about 70% by weight of the gum. Sugar bulking agents generally include saccharide-containing components commonly known in the chewing gum art, including, but not limited to, sucrose, dextrose, maltose, dextrin, dried invert sugar, fructose, levulose, galactose, corn syrup solids, and the like, alone or in combination. In sugarless gums, sugar alcohols such as sorbitol, maltitol, erythritol, isomalt, mannitol, xylitol and combinations thereof are substituted for sugar bulking agents. Combinations of sugar and sugarless bulking agents may also be used.

In addition to the above bulk sweeteners, chewing gums typically comprise a binder/softener in the form of a syrup or high-solids solution of sugars and/or sugar alcohols. In the case of sugar gums, corn syrups and other dextrose syrups (which contain dextrose and significant amounts higher saccharides) are most commonly employed. These include syrups of various DE levels including high-maltose syrups and high fructose syrups. In the case of sugarless products, solutions of sugar alcohols including sorbitol solutions and hydrogenated starch hydrolysate syrups are commonly used. Also useful are syrups such as those disclosed in U.S. Pat. No. 5,651,936 and US 2004-234648 which are incorporated herein by reference. Such syrups serve to soften the initial chew of the product, reduce crumbliness and brittleness and increase flexibility in stick and tab products. They may also control moisture gain or loss and provide a degree of sweetness depending on the particular syrup employed. In the case of syrups and other aqueous solutions, it is generally desirable to use the minimum practical level of water in the solution to the minimum necessary to keep the solution free-flowing at acceptable handling temperatures. The usage level of such syrups and solutions should be adjusted to limit total moisture in the gum to less than 3 wt. %, preferably less than 2 wt. % and most preferably less than 1 wt. %.

High intensity artificial sweeteners can also be used in combination with the above-described sweeteners. Preferred sweeteners include, but are not limited to sucralose, aspartame, salts of acesulfame, alitame, neotame, saccharin and its salts, cyclamic acid and its salts, glycyrrhizin, stevia and stevia compounds such as rebaudioside A, dihydrochalcones, thaumatin, monellin, lo han guo and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extrusion may be used to achieve the desired release characteristics.

Usage level of the artificial sweetener will vary greatly and will depend on such factors as potency of the sweetener, rate of release, desired sweetness of the product, level and type of flavor used and cost considerations. Thus, the active level of artificial sweetener may vary from 0.02 to about 8% by weight. When carriers used for encapsulation are included, the usage level of the encapsulated sweetener will be proportionately higher.

If a low calorie gum is desired, a low caloric bulking agent can be used. Examples of low caloric bulking agents include: erythritol, polydextrose; Raftilose, Raftilin; fructooligosaccharides (NutraFlora); Palatinose oligosaccharide; Guar Gum Hydrolysate (Sun Fiber); or indigestible dextrin (Fibersol). However, other low calorie bulking agents can be used. In addition, the caloric content of a chewing gum can be reduced by increasing the relative level of gum base while reducing the level of caloric sweeteners in the product. This can be done with or without an accompanying decrease in piece weight.

A variety of flavoring agents can be used. The flavor can be used in amounts of approximately 0.1 to about 15 weight percent of the gum, and preferably, about 0.2 to about 5%. Flavoring agents may include essential oils, synthetic flavors or mixtures thereof including, but not limited to, oils derived from plants and fruits such as citrus oils, fruit essences, peppermint oil, spearmint oil, other mint oils, clove oil, oil of wintergreen, anise and the like. Artificial flavoring agents and components may also be used. Natural and artificial flavoring agents may be combined in any sensorially acceptable fashion. Sensate components which impart a perceived tingling or thermal response while chewing, such as a cooling or heating effect, also may be included. Such components include cyclic and acyclic carboxamides, menthol derivatives, and capsaicin among others. Acidulants may be included to impart tartness.

In addition to typical chewing gum components, chewing gums of the present invention may include active agents such as dental health actives such as minerals, nutritional supplements such as vitamins, health promoting actives such as antioxidants for example resveratrol, flavanols, stimulants such as caffeine, medicinal compounds and other such additives. These active agents may be added neat to the gum mass or encapsulated using known means to enhance or prolong release and/or prevent degradation. The actives may be added to coatings, rolling compounds and liquid or powder fillings where such are present.

It may be desirable to add components to the gum or gum base composition which enhance environmental degradation of the chewed cud after it is chewed and discarded. For example, in the case of a polyester elastomer, an esterase enzyme may be added to accelerate decomposition of the polymer. Optionally, the enzyme or other degradation agent may be encapsulated by spray drying, fluid bed encapsulation or other means to delay the release and prevent premature degradation of the cud.

The present invention may be used with a variety of processes for manufacturing chewing gum including batch mixing, continuous mixing and tableted gum processes.

Chewing gum bases of the present invention may be easily prepared by combining an elastomer with a suitable plasticizer as previously disclosed. If additional ingredients such as softeners, plastic resins, emulsifiers, fillers, colors and antioxidants are desired, they may be added by conventional batch mixing processes or continuous mixing processes. Process temperatures are generally from about 120° C. to about 180° C. in the case of a batch process. If it is desired to combine the plasticized or unplasticized controlled flow polymer with conventional elastomers, it is preferred that the conventional elastomers be formulated into a conventional gum base before combining with the controlled flow polymer gum base. To produce the conventional gum base, the elastomers are first ground or shredded along with filler. Then the ground elastomer is transferred to a batch mixer for compounding. Essentially any standard, commercially available mixer known in the art (e.g., a Sigma blade mixer) may be used for this purpose. The first step of the mixing process is called compounding. Compounding involves combining the ground elastomer with filler and elastomer plasticizer (elastomer solvent). This compounding step generally requires long mixing times (30 to 70 minutes) to produce a homogeneous mixture. After compounding, additional filler and elastomer plasticizer are added followed by PVAc and finally softeners while mixing to homogeneity after each added ingredient. Minor ingredients such as antioxidants and color may be added at any time in the process. The conventional base is then blended with the controlled flow polymer base in the desired ratio. Whether the controlled flow polymer is used alone or in combination with conventional elastomers, the completed base is then extruded or cast into any desirable shape (e.g., pellets, sheets or slabs) and allowed to cool and solidify.

Alternatively, continuous processes using mixing extruders, which are generally known in the art, may be used to prepare the gum base. In a typical continuous mixing process, initial ingredients (including ground elastomer, if used) are metered continuously into extruder ports various points along the length of the extruder corresponding to the batch processing sequence. After the initial ingredients have massed homogeneously and have been sufficiently compounded, the balance of the base ingredients are metered into ports or injected at various points along the length of the extruder. Typically, any remainder of elastomer component or other components are added after the initial compounding stage. The composition is then further processed to produce a homogeneous mass before discharging from the extruder outlet. Typically, the transit time through the extruder will be substantially less than an hour. If the gum base is prepared from controlled flow polymer without conventional elastomers, it may be possible to reduce the necessary length of the extruder needed to produce a homogeneous gum base with a corresponding reduction in transit time. In addition, the controlled flow polymer need not be pre-ground before addition to the extruder. It is only necessary to ensure that the controlled flow polymer is reasonably free-flowing to allow controlled, metered feeding into the extruder inlet port.

Exemplary methods of extrusion, which may optionally be used in conjunction with the present invention, include the following, the entire contents of each being incorporated herein by reference: (i) U.S. Pat. No. 6,238,710, claims a method for continuous chewing gum base manufacturing, which entails compounding all ingredients in a single extruder; (ii) U.S. Pat. No. 6,086,925 discloses the manufacture of chewing gum base by adding a hard elastomer, a filler and a lubricating agent to a continuous mixer; (iii) U.S. Pat. No. 5,419,919 discloses continuous gum base manufacture using a paddle mixer by selectively feeding different ingredients at different locations on the mixer; and, (iv) yet another U.S. Pat. No. 5,397,580 discloses continuous gum base manufacture wherein two continuous mixers are arranged in series and the blend from the first continuous mixer is continuously added to the second extruder.

Chewing gum is generally manufactured by sequentially adding the various chewing gum ingredients to commercially available mixers known in the art. After the ingredients have been thoroughly mixed, the chewing gum mass is discharged from the mixer and shaped into the desired form, such as by rolling into sheets and cutting into sticks, tabs or pellets or by extruding and cutting into chunks.

Generally, the ingredients are mixed by first softening or melting the gum base and adding it to the running mixer. The gum base may alternatively be softened or melted in the mixer. Color and emulsifiers may be added at this time.

A chewing gum softener such as glycerin can be added next along with part of the bulk portion. Further parts of the bulk portion may then be added to the mixer. Flavoring agents are typically added with the final part of the bulk portion. The entire mixing process typically takes from about five to about fifteen minutes, although longer mixing times are sometimes required.

In yet another alternative, it may be possible to prepare the gum base and chewing gum in a single high-efficiency extruder as disclosed in U.S. Pat. No. 5,543,160. Chewing gums of the present invention may be prepared by a continuous process comprising the steps of: a) adding gum base ingredients into a high efficiency continuous mixer; b) mixing the ingredients to produce a homogeneous gum base, c) adding at least one sweetener and at least one flavor into the continuous mixer, and mixing the sweetener and flavor with the remaining ingredients to form a chewing gum product; and d) discharging the mixed chewing gum mass from the single high efficiency continuous mixer. In the present invention, it may be necessary to first blend the controlled flow polymer with a suitable plasticizer before incorporation of additional gum base or chewing gum ingredients. This blending and compression process may occur inside the high-efficiency extruder or may be performed externally prior to addition of the plasticized controlled flow polymer composition to the extruder.

Of course, many variations on the basic gum base and chewing gum mixing processes are possible.

After mixing, the chewing gum mass may be formed, for example by rolling or extruding into and desired shape such as sticks, tabs, chunks or pellets. The product may also be filled (for example with a liquid syrup or a powder) and/or coated for example with a hard sugar or polyol coating using known methods.

After forming, and optionally filling and/or coating, the product will typically be packaged in appropriate packaging materials. The purpose of the packaging is to keep the product clean, protect it from environmental elements such as oxygen, moisture and light and to facilitate branding and retail marketing of the product.

### EXAMPLES

### Example 1

A tri-block copolymer in the form A-B-A having a soft mid-block comprising poly-6-methyl-ε-caprolactone and hard end-blocks comprising polylactide having a T_{g} below 70° C. was produced according to copending application U.S. 61/241,080. The polymer blocks had molecular weights of 7-19-7 kDa. This polymer was combined with low molecular weight polyvinylacetate in a ratio of 60:40 Tri-block copolymer:PVAc to produce a gum base. The gum base was used to make a chewing gum according to Table 1. The resulting chewing gum is designated as Example 1.

TABLE 1

| | Example 1 (wt. %) |
|---|---|
| LML/PVAc Gum Base | 32.01 |
| Sorbitol | 54.32 |
| Maltitiol | 1.94 |
| Triacetin | 1.97 |
| Acetylated Monoglyceride | 2.01 |
| Lecithin | 0.48 |
| Glycerin | 4.85 |
| Peppermint Flavor | 1.94 |
| High Intensity Sweetener | 0.48 |
| Total | 100.00 |

### Example 2

A second tri-block copolymer in the form A-B-A having a soft mid-block comprising poly-6-methyl-ε-caprolactone and hard end-blocks comprising polylactide having a T_{g} below 70° C. was produced according to copending application U.S. 61/241,080. The polymer blocks had molecular weights of 33-98-33 kDa. This polymer was combined with a diblock copolymer having the same A and B blocks but with molecular weights of 5.5-9 kDa and chewing gum ingredients according to Table 2 to produce a chewing gum designated Example 2.

TABLE 2

| | Example 2 (wt. %) |
|---|---|
| LML tri-block copolymer | 9.58 |
| LM di-block copolymer | 38.31 |
| Microcrystalline Wax | 1.85 |
| Sorbitol | 35.18 |
| Glycerin | 8.80 |
| Peppermint Flavor | 5.30 |
| High Intensity Sweetener | 0.98 |
| Total | 100.00 |

### Example 3

A chewing gum containing crosslinked polyacrylate microparticles was prepared according to Table 3. The chewing gum is designated as Example 3.

TABLE 3

| | Example 3 (wt. %) |
|---|---|
| Crosslinked Polymeric Microspheres | 32.33 |
| Calcium Carbonate | 12.95 |
| Sorbitol | 45.72 |
| Glyceriin | 3.92 |
| Maltitol | 1.82 |
| Peppermint Flavor | 2.25 |
| Lecithin | 0.44 |
| Encapsulated High Intensity Sweeteners | 0.57 |
| Total | 100.00 |

### Example 4

A gum base containing a high level of low molecular weight polyethylene (Honeywell A-C® 9A weight average molecular weight about 13500 daltons, polydispersity about 2.0) was prepared and used to produce a chewing gum according to Table 4. This chewing gum is designated as Example 4.

TABLE 4

| | Example 4 |
|---|---|
| | (wt. %) |
| Butyl Rubber | 6.14 |
| Talc | 2.09 |
| Calcium Carbonate | 0.22 |
| Polyisobutylene (150,000 daltons) | 6.24 |
| Terpene Resin | 9.44 |
| Estergum | 0.99 |
| Polyethylene (Honeywell A-C ® 9A) | 57.85 |
| Hydrogenated Vegetable Oil | 11.26 |
| Glycerol Monostearate | 0.41 |
| Triacetin | 0.28 |
| Paraffin | 0.35 |
| Lecithin | 2.83 |
| Polyvinyl Acetate (High MW) | 1.88 |
| BHA | 0.02 |
| Total (Gum Base) | 100.00 |
| Gum Base (form above) | 36.00 |
| Erythritol | 52.50 |
| Glycerin | 6.00 |
| Peppermint Flavor | 3.35 |
| Lecithin | 1.00 |
| Encapsulated and Unencapsulated High | 1.15 |
| Intensity Sweeteners | |
| Total | 100.00 |

Comparative Run 5. A chewing gum was made using an ultra-high molecular weight polyvinyl acetate according to Example 3 in US 2003/198710. This chewing gum is said to have improved removability.

Comparative Run 6: A chewing gum was made using an ultra-high molecular weight polyvinyl acetate according to Example 4 in US 2003/198710. This chewing gum is said to have improved removability.

Comparative Run 7: A chewing gum was prepared from a thermoplastic polyolefin elastomer according to Example 142 in US 2008/233234 and was designated as Comparative Run 7.

Comparative Runs 8-10: Chewing gum bases and gums were made according to formulas in Table 5.

TABLE 5

| | Comp. | Comp. | Comp. |
|---|---|---|---|
| | Run 8 | Run 9 | Run 10 |
| | (wt. %) | (wt. %) | (wt. %) |
| Calcium Carbonate | 24.36 | 24.36 | 30.34 |
| Butyl Rubber | 11.08 | 12.32 | 11.08 |
| Polyisobutylene | 6.91 | 7.68 | 6.91 |
| Estergums | 19.00 | 11.01 | 11.01 |
| Polyvinyl Acetate (Low MW) | 12.01 | 15.98 | 12.01 |
| Hydrogenated Vegetable oil | 23.47 | 25.48 | 25.48 |
| Glycerol Monostearate | 3.13 | 3.13 | 3.13 |
| BHT | 0.04 | 0.04 | 0.04 |
| Total (Gum Base) | 100.00 | 100.00 | 100.00 |
| Gum Base (from above) | 25.90 | 25.89 | 25.90 |
| Low Moisture Sugarless Syrup* | 35.72 | 35.72 | 35.73 |
| Sorbitol | 32.90 | 17.06 | 16.68 |
| Mannitol | — | 17.06 | 16.68 |
| Peppermint Flavor | 2.42 | 1.21 | 1.21 |
| Aspartame | 0.08 | 0.08 | 0.10 |
| Encapsulated High Intensity Sweeteners | 2.18 | 2.18 | 2.90 |
| Glycerin | 0.80 | 0.80 | 0.80 |
| Total (Chewing gum) | 100.00 | 100.00 | 100.00 |

*Prepared according to U.S. Pat. No. 5,651,936.

Comparative Run 11: A sample of a commercial chewing gum, US Trident® Bubble Gum manufactured by Cadbury, was purchased from a retail market.

Comparative Run 12: A sample of a commercial chewing gum, US Hubba Bubba® Outrageous Original Bubble Gum manufactured by Wm. Wrigley Jr. Company, Chicago, Ill. USA was purchased from a retail market.

Comparative Run 13: A lab scale chewing gum batch was prepared from the commercial formula used to produce British Wrigley's Extra® Peppermint except that the product was not coated. This product was designated as Comparative Run 13.

Comparative Run 14: A chewing gum containing a low polarity gum base as taught in U.S. 61/325,529 was prepared according to the formula in Table 6.

TABLE 6

| | Example 14 |
|---|---|
| | Wt. % |
| Microcyrstalline Wax | 78.08 |
| Butyl Rubber | 10.91 |
| Acetylated Monoglyceride | 9.09 |
| Talc | 1.92 |
| Total Gum Base | 100.00 |
| Gum Base (from above) | 33.00 |
| Sorbitol | 59.89 |
| Glycerin (99%) | 4.00 |
| Peppermint Flavor | 1.84 |
| Lecithin | 0.45 |
| Encapsulated and Unencapsulated High | 0.82 |
| Intensity Sweeteners | |
| Total Chewing Gum | 100.00 |

Comparative Run 15: A lab scale batch of chewing gum containing a high molecular weight polyethylene gum base based on “Base 2” of US 2009/0304857. The gum base contained Epolene C-17 (Westlake Chemical, Houston, Tex., USA) highly branched polyethylene having Mn of approximately 15,000 and Mw of approximately 107,000. The base and gum formulas are shown in Table 7.

Comparative Run 16: A lab scale batch of chewing gum containing a high molecular weight polyethylene gum base based on “Base 6” of US 2009/0304857. The gum base contained Epolene N-10 (Westlake Chemical, Houston, Tex., USA) polyethylene having Mn of approximately 3,000 and Mw of approximately 10,000. The base and gum formulas are shown in Table 7.

TABLE 7

| | Comp. | Comp. |
|---|---|---|
| | Run 15 | Run 16 |
| | (wt. %) | (wt. %) |
| Epolene C-17 Polyethylene | 7.00 | — |
| Epolene N-10 Polyethylene | — | 7.00 |
| Butyl Rubber | 8.00 | 8.00 |
| Calcium Carbonate | 20.00 | 20.00 |
| Terpene Resin | 20.00 | 20.00 |
| Polyvinyl Acetate (Low MW) | 20.00 | 20.00 |
| Hydrogenated Vegetable oil | 20.00 | 20.00 |
| Glycerol Monostearate | 4.00 | 4.00 |
| Lecithin | 1.00 | 1.00 |
| Total (Gum Base) | 100.00 | 100.00 |
| Gum Base (from above) | 40.00 | 40.00 |
| Hydrogenated Starch Hydrolysate Syrup (85%) | 6.00 | 6.00 |
| Sorbitol | 45.60 | 45.60 |
| Xylitol | 6.00 | 6.00 |
| Peppermint Flavor | 2.00 | 2.00 |
| High Intensity Sweeteners | 0.40 | 0.40 |
| Total (Chewing gum) | 100.00 | 100.00 |

Comparative Run 17: A sample of a commercial chewing gum, Chicza Lime Organic Mayan Rainforest Chewing gum manufactured by Consocio Chiclero SC de RL, was purchased from a retail market in the UK.

Comparative Run 18: A sample of a commercial chewing gum, US Eclipse® Peppermint Chewing Gum manufactured by Wm. Wrigley Jr. Company, Chicago, Ill. USA, was purchased from a retail market.

Comparative Run 19: A sample of a commercial chewing gum, Glee Gum Peppermint All Natural Gum Made with Rainforest Chicle! manufactured by Verve, Inc., was purchased from a retail market in the US.

Comparative Run 20: A sample of a commercial chewing gum, Artificially Flavored Melon, Orange, Strawberry and Grape Bubblegum manufactured by Marukawa, Inc., was purchased from a retail market in the US. The package contained four differently flavored pieces, the melon flavor was designated as Comparative Run 20.

Comparative Run 21: A sample of a commercial chewing gum, Natural Chicle Lime Citrus chewing gum manufactured by Orion, was acquired in South Korea.

Comparative Run 22: A sample of a commercial chewing gum, Razzles™ (various flavors) tableted chewing gum manufactured by Concord Confections, was purchased from a retail market in the US.

Comparative Run 23: A sample of a commercial chewing gum, Trident® White Peppermint manufactured by Cadbury, was acquired.

Comparative Run 24: A sample of a commercial chewing gum, Jila Peppermint manufactured by Ferndale, was acquired.

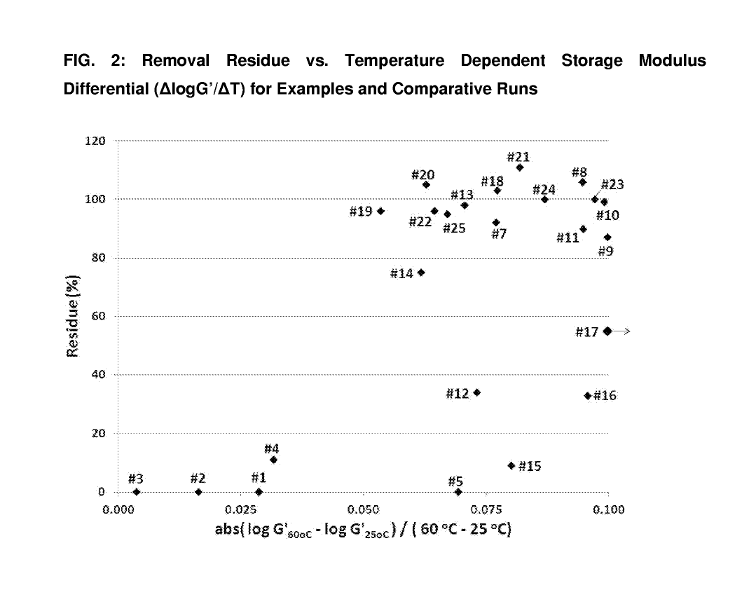

The chewing gums of Examples/Comparative Runs 1-24 were tested on a rotational rheometer according to the previously described test procedure. Removability testing according to the previously described procedure was performed on most examples/Comparative Runs with multiple samples (typically n=5) tested where this was possible. Representative plots of G′ vs. T are shown in FIG. 1. For each cud, the temperature dependent storage modulus differential was calculated. The data is presented in Table 8 and Δ log G′/ΔT was plotted against the percent residue remaining after the removability test. (See FIG. 2.) As can be seen, the chewing gum cuds having temperature dependent storage modulus differential (Δ log G′/ΔT) of greater than about 0.05 tended to adhere strongly to the concrete surface, although this was not true in every case. Conversely, cuds from chewing gums of the present invention having Δ log G′/ΔT of less than 0.05 in most cases were readily removable from concrete, leaving essentially no residue after one pass with a metal scraper. While not all cuds having the claimed chewing gums temperature dependent storage modulus differential may be so easily removable, it is believed that most such cuds will exhibit improved removability compared to typical commercial products.

TABLE 8

| | | | | | | % |
|---|---|---|---|---|---|---|
| Ex./ | G′ (Pa) | G′ (Pa) | G′ (Pa) | ΔlogG′/ | % | Residue |
| C.R. # | @ 25° C. | @ 37° C. | @ 60° C. | ΔT | Residue | St. Dev. |
| Ex. 1 | 1.61E+06 | 8.08E+05 | 1.59E+05 | 0.029 | 0 | NA |
| Ex. 2 | 1.10E+05 | 6.79E+04 | 2.93E+04 | 0.016 | 0 | 0 |
| Ex. 3 | 4.18E+04 | 3.63E+04 | 3.08E+04 | 0.004 | 0 | 0 |
| Ex. 4 | 6.27E+07 | 2.24E+07 | 4.89E+06 | 0.032 | 11 | 14 |
| C.R. 5 | 2.13E+07 | 3.76E+06 | 7.97E+04 | 0.069 | 0 | 0 |
| C.R. 6 | 1.32E+07 | 3.27E+06 | 1.87E+03 | 0.110 | NA | NA |
| C.R. 7 | 6.26E+06 | 5.34E+05 | 1.25E+04 | 0.077 | 92 | 3 |
| C.R. 8 | 1.25E+07 | 1.97E+06 | 6.08E+03 | 0.095 | 106 | 4 |
| C.R. 9 | 2.17E+07 | 2.52E+06 | 6.96E+03 | 0.100 | 87 | 13 |
| C.R. 10 | 5.12E+07 | 5.71E+06 | 1.73E+04 | 0.099 | 99 | 9 |
| C.R. 11 | 5.16E+07 | 2.36E+06 | 2.47E+04 | 0.095 | 90 | 8 |
| C.R. 12 | 1.60E+07 | 5.79E+05 | 4.42E+04 | 0.073 | 34 | 32 |
| C.R. 13 | 5.62E+06 | 4.73E+05 | 1.90E+04 | 0.071 | 98 | 2 |
| C.R. 14 | 6.12E+07 | 1.92E+07 | 4.23E+05 | 0.062 | 75 | 9 |
| C.R. 15 | 1.04E+07 | 1.76E+06 | 1.64E+04 | 0.080 | 9 | 6 |
| C.R. 16 | 8.34E+06 | 1.34E+06 | 3.73E+03 | 0.096 | 33 | 20 |
| C.R. 17 | 7.40E+07 | 2.75E+07 | 7.64E+02 | 0.142 | 56 | 20 |
| C.R. 18 | 1.58E+07 | 1.57E+06 | 3.12E+04 | 0.077 | 103 | 6 |
| C.R. 19 | 8.76E+06 | 8.76E+06 | 1.18E+05 | 0.053 | 96 | 12 |
| C.R. 20 | 3.18E+06 | 3.18E+06 | 2.01E+04 | 0.063 | 105 | 13 |
| C.R. 21 | 1.81E+07 | 3.38E+06 | 2.47E+04 | 0.082 | 111 | 6 |
| C.R. 22 | 3.93E+07 | 7.04E+06 | 2.16E+05 | 0.065 | 96 | 8 |
| C.R. 23 | 4.61E+07 | 7.17E+06 | 1.84E+04 | 0.097 | 100 | 6 |
| C.R. 24 | 5.90E+07 | 1.02E+07 | 5.35E+04 | 0.087 | 100 | 5 |

1. A chewing gum which, upon chewing, forms a cud having a temperature dependent storage modulus differential (Δ log G′/ΔT) of less than 0.050.

2. The chewing gum of claim 1 wherein the chewing gum comprises a water-insoluble gum base portion and a water-soluble bulk portion.

3. A chewing gum of claim 1 wherein the chewing gum comprises a tri-block copolymer in the form A-B-A or A-B-C having a soft mid-block and hard end-blocks wherein the soft mid-block comprises at least 30 wt. % of the tri-block copolymer and wherein the hard end-blocks each have a T_{g} below 70° C.

4. The chewing gum of claim 3 wherein the chewing gum further comprises a diblock copolymer.

5. The chewing gum of claim 3 wherein the tri-block copolymer comprises a soft mid-block and hard end-blocks wherein the soft mid-block comprises at least 30 wt. % of the tri-block copolymer and wherein the hard end-blocks each have a T_{g} below 70° C.

6. The chewing gum of claim 5 wherein the hard end-blocks each have a T_{g} below 60° C.

7. The chewing gum of claim 5 wherein the hard end-blocks each have a T_{g} between 40° C. and 60° C.

8. The chewing gum of claim 1 wherein the chewing gum comprises crosslinked polymeric microparticles.

9. The chewing gum of claim 8 wherein the crosslinked polymeric microparticles have a glass transition temperature of less than about 30° C.

10. The chewing gum of claim 8 wherein the crosslinked polymeric microparticles have a glass transition temperature of less than 10° C.

11. The chewing gum of claim 8 wherein the crosslinked polymeric microparticles have a glass transition temperature of less than 0° C.

12. The chewing gum of claim 8 wherein the crosslinked polymeric microparticles have a largest dimension of at least 0.1 microns.

13. The chewing gum of claim 8 wherein the crosslinked polymeric microparticles have a largest dimension of at least 0.5 microns.

14. The chewing gum of claim 8 wherein the crosslinked polymeric microparticles have a largest dimension of at least 10 microns.

15. The chewing gum of claim 8 wherein the crosslinked polymeric microparticles have a largest dimension of less than 1000 microns.

16. The chewing gum of claim 8 wherein the crosslinked polymeric microparticles have a largest dimension of less than 500 microns.

17. The chewing gum of claim 8 wherein the crosslinked polymeric microparticles have a largest dimension of less than 100 microns.

18. The chewing gum of claim 2 wherein the water-insoluble base portion comprises 45 to 95% by weight of polyethylene having a weight average molecular weight between 2000 and 23000 daltons.

19. The chewing gum of claim 18 wherein the water-insoluble base portion comprises 50 to 75% by weight of polyethylene having a weight average molecular weight between 2000 and 23000 daltons.

20. The chewing gum of claim 18 wherein the water-insoluble base portion comprises 55 to 70% by weight of polyethylene having a weight average molecular weight between 2000 and 23000 daltons.

21. The chewing gum of claim 3 wherein the polymer is a food grade polymer.

22. The chewing gum of claim 1 which, upon chewing, forms a cud having a temperature dependent storage modulus differential (Δ log G′/ΔT) of less than 0.045.

23. The chewing gum of claim 1 which, upon chewing, forms a cud having a temperature dependent storage modulus differential (Δ log G′/ΔT) of less than 0.040.

24. The chewing gum of claim 1 which, upon chewing, forms a cud having a temperature dependent storage modulus differential (Δ log G′/ΔT) of less than 0.035.

25. The chewing gum of claim 1 which, upon chewing, forms a cud having a temperature dependent storage modulus differential (Δ log G′/ΔT) of less than 0.030.

26. The chewing gum of claim 1 wherein the chewing gum comprises less than 10% polyvinyl acetate.

27. The chewing gum of claim 1 wherein the chewing gum comprises less than 10% triglycerides.

28. The chewing gum of claim 1 wherein the chewing gum is essentially free of proteins.

29. The chewing gum of claim 1 wherein the chewing gum, upon chewing, produces a cud having storage modulus (G′) of from 10⁵ Pa to 10⁷ Pa at 37° C.

30. The chewing gum of claim 1 wherein the chewing gum, upon chewing, produces a cud which leaves no more than 20% of the original gum cud surface area as residue after a single pass of a metal scraper.
